(19) United States
(12) Patent Application Publication
(10) Pub. No.: US 2012/0026961 A1
(43) Pub. Date: Feb. 2, 2012

(54) NETWORK MANAGEMENT SYSTEM

(75) Inventors: Frank Pittmann, Berlin (DE); Andreas Platzer, Berlin (DE)

(73) Assignee: NOKIA SIEMENS NETWORKS OY, Espoo (FI)

(21) Appl. No.: 13/255,927

(22) PCT Filed: Mar. 25, 2009
(86) PCT No.: PCT/EP2009/053498

§ 371 Date: Oct. 12, 2011

(51) Int. Cl. H04W 72/04

(52) U.S. Cl. 370/329

(57) ABSTRACT

An arrangement for enabling network operators (typically mobile network operators) to dynamically trade capacity on their systems is described, thereby enabling such operators to fill their network capacity with traffic from other providers and also enabling service providers that have either insufficient or no network infrastructure to lease capacity from network operators. Network capacity is allocated between operators on the basis of both desired capacity and predetermined resources allocation rules.

The invention is directed to network management systems. In particular, the invention is related to network management systems that enable the trading of system resources by network operators (such as communication networks operators).

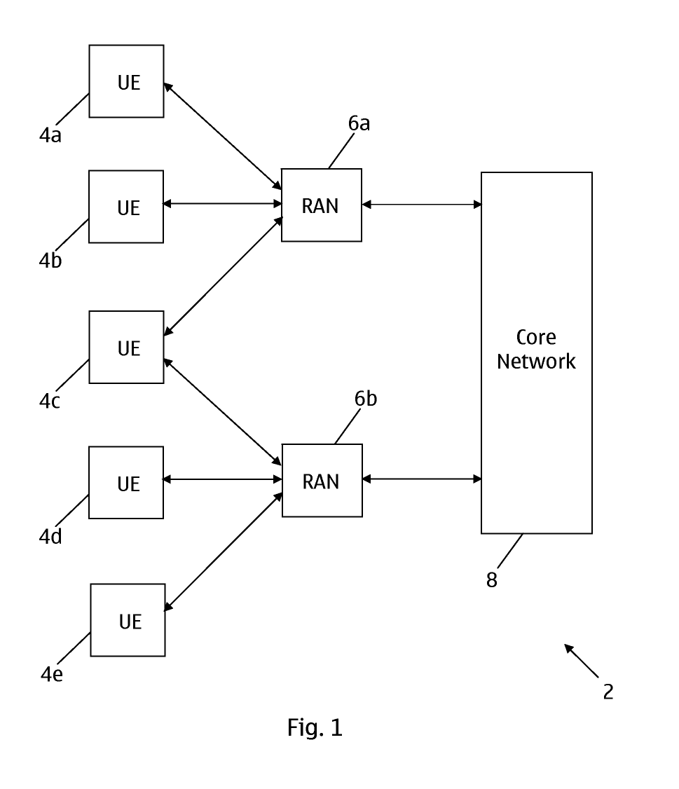

FIG. 1 is a block diagram showing, in broad terms, a typical system for providing mobile communication services. The system, indicated generally by the reference numeral 2, comprises a plurality of user equipments (UEs) 4, a plurality of radio access networks 6 and a core network 8.

In the exemplary system 2, five UEs are shown (labelled 4a, 4b, 4c, 4d and 4e respectively) and two radio access networks (RANs) are shown (labelled 6a and 6b). As shown in FIG. 1, UEs 4a and 4b are connectable to RAN 6a, UEs 4d and 4e are connectable to RAN 6b and UE 4c is connectable to both RAN 6a and RAN 6b. Of course, the number of UEs, the number of RANs and the connections between the UEs and RANs varies considerably from system to system.

The RANs 6 and the core network 8 are typically provided by a single mobile network operator and the users of the UEs 4 each have access only to the radio access networks and core networks provided by that mobile network operator.

With growing competitive intensity and rapid price declines, mobile network operators are facing increased margin pressure and the need to systematically improve their cost position. To address this reality, operators are adopting multiple strategies for addressing network costs. One approach is to share parts of mobile networks between more than one operator. The ability to share parts of mobile networks with competitors allows each operator to reduce capital expenditure, since infrastructure elements can be jointly utilized. Also, sharing network resources enables each operator to reduce operational expenditure as the underlying operations are performed together.

Resources sharing can enable telephone networks, mobile operators, satellite providers and other telecommunications companies to trade capacity on their systems. Network operators spotting potential bottlenecks can buy extra capacity, ensuring the smooth functioning of telephone services, cellular networks, the Internet and other communications links. Similarly, network operators with excess capacity can sell bandwidth, helping to limit the financial losses that occur when networks sit idle.

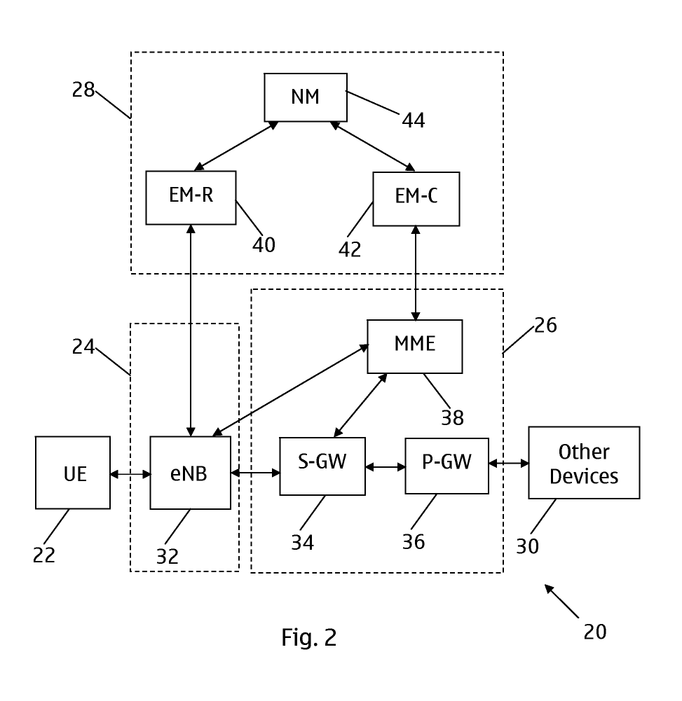

FIG. 2 is a block diagram of an exemplary mobile communication system, indicated generally by the reference numeral 20, in accordance with Long Term Evolution (LTE), which is a project within the Third Generation Partnership Project (3GPP). As discussed below, the 3GPP LTE system enables some sharing of network resources.

The mobile communication system 20 comprises user equipment (UE) 22, radio access network (RAN) 24, evolved packet core 26, network management system 28 and a number of other devices and networks 30. The UE 22 and radio access network 24 are similar to the UEs 4a, 4b, 4c, 4d and 4e and RANs 6a and 6b described above with reference to FIG. 1. Further, the evolved packet core 26 and the network management system 28 can be used to provide the functionality of the core network 8 of FIG. 1. Of course, although only a single UE 22 and a single RAN 24 are shown in FIG. 2, the system 20 will typically include a plurality of UEs 22 and a plurality of RANs 24, as described above with reference to FIG. 1.

The radio access network 24 (often referred to as an evolved radio access network) comprises a single node, referred to as eNodeB (eNB) 32. The eNB 32 acts as an interface between the UE 22 and the evolved packet core 26.

The evolved packet core 26 comprises a serving gateway (S-GW) 34, packet data network gateway (P-GW) 36 and one or more mobility management entities (MMEs) 38. The S-GW 34 is in two-way communication with eNB 32 and with the P-GW 36. The S-GW 34 is used to forward packets of data received from the eNB 32 to either the P-GW 36 or one of the MMEs 38. The MMEs 38 are in two-way communication with the eNB 32 and the S-GW 34. The P-GW 36 is in two-way communication with the other devices and networks 30. The other devices and network 30 may take a variety of different forms and may include, for example, Internet Protocol (IP) services.

The network management system 28 comprises a radio network element manager (EM-R) 40, core network element manager (EM-C) 42 and a network manager (NM) 44. The EM-R 40 is in two-way communication with the eNB 32, the EM-C 42 is in two-way communication with the MMEs 38 and the NM 44 is in two-way communication with both the EM-R 40 and the EM-C 42.

The MME 38 is a key control node for the evolved packet core 26. The MME 38 is responsible for a number of control functions, such as idle mode UE tracking, bearing activation/deactivation, authenticating the user, S-GW and P-GW selection, and MME selection for handovers with MME change. The skilled person will be aware of the many other functions provided by the MME 38.

The LTE architecture described above with reference to FIG. 2 enables mobile network operators to reduce costs by enabling multiple mobile network operators to share the radio resources provided by the radio access network 24. This is discussed, for example, in 3GPP TS 36.300: “Evolved Universal Terrestrial Radio Access (E-UTRA) and Evolved Universal Terrestrial Radio Access (E-UTRAN); Overall description; Stage 2” (available at www.3gpp.org).

Although the sharing of radio resources is known, the sharing of core network facilities presents different problems. In particular, providing an efficient means to enable core network resources to be shared in a dynamic manner presents problems in a multi-vendor environment. Currently 3GPP's SAE/LTE network environment lacks an efficient means to enable dynamic resources brokerage that could be easily introduced in 3GPP's networks.

The present invention seeks to address at least some of the problems outlined above.

The invention provides a method comprising: determining, for a communication network, network capacity desired by each of a plurality of operators; and allocating network capacity for the communication network to the plurality of operators, wherein the network capacity is allocated on the basis of the determined desired network capacities and on the basis of predetermined resources allocation rules.

The invention also provides an apparatus (such as a control system/network management system for a communications network) comprising a resources allocation enforcement module adapted to allocate network capacity of a communication network (such as a mobile network) to each of a plurality of operators that are sharing said network capacity, wherein, for each operator, network capacity is allocated on the basis of predetermined resources allocation rules. The network capacity may also be allocated on the basis of determined desired network capacities.

The invention further provides a radio access network for a mobile communication system, wherein a plurality of operators share network capacity of the mobile communication system, the radio access network comprising a control system for providing or denying access to the operators on the basis of determined desired network capacities of the operators and on the basis of predetermined resources allocation rules. The radio access network may make use of overload message to deny access. The overload messages may be operator-dependent.

An advantage of the present invention is that, in addition to network operators (e.g. mobile network operators) sharing network resources with other network operators (e.g. mobile network operators), the invention enables network resources to be provided to companies without network resources of their own. In this way, service providers can make use of network resources to enable users to access their services, without needing to invest in creating expensive network resources of their own and companies with network resources can sell or lease spare capacity to other providers, including providers with no network resources of their own. Thus, network operators can dynamically trade capacity on their systems.

In many forms of the invention, capacity allocation is dependent on the identity of an operator requesting network capacity.

The invention enables sharing of resources between network operators, depending on agreed resources allocation rules (which may be based on one or more service level agreements). Furthermore, the invention enables network resources to be allocated on a dynamic basis and on the basis of desired usage, rather than, for example, measuring past usage and checking that usage against a service level agreement (SLA).

In many forms of the invention, the communication network is a mobile communication network.

At least some of said operators may be mobile network operators.

Some of said operators may be mobile virtual network operators. For example, some of the operators may not have their own base stations, and therefore need to use capacity in base stations provided by other entities. Mobile virtual network operators may have other network infrastructure, such as a core network and network management functions.

Some of said operators may be service providers. For example, service providers may not have their own base stations and may not have other network infrastructure, such as a core network. Such service provides may lease network resources from network infrastructure providers.

In some forms of the invention, for a first operator of the plurality of operators, the resources allocation rules define a minimum network capacity, which network capacity is always available for the first operator. A minimum network capacity may be set for more than one of the plurality of operators and may, in some forms of the invention, be set for all of the plurality of operators.

In some forms of the invention, for a first operator of the plurality of operators, the resources allocation rules define a granted network capacity, which network capacity is always available for the said operator, if it is determined that that network capacity is desired by the first operator. A granted network capacity may be set for more than one of the plurality of operators and may, in some forms of the invention, be set for all of the plurality of operators.

In some forms of the invention, for a first operator of the plurality of operators, the resources allocation rules define a maximum network capacity, which network capacity is available for the said first operator, if it is determined that that network capacity is desired by the first operator and that that network capacity is available. A maximum network capacity may be set for more than one of the plurality of operators and may, in some forms of the invention, be set for all of the plurality of operators. In the event that a maximum network capacity is not available, the operator concerned may be granted as much network capacity as possible (up to, and including, the capacity desired by the operator).

An overload procedure may be used to restrict access to said network capacity for one or more of said plurality of operators. For example, an overload message may be sent (for example by a mobility management entity (MME)) to indicate that any further access requests for a particular network should be denied (possibly, with the exception of emergency access requests such as telephone calls to emergency services). The restriction of access to network capacity may be dependent on the operator concerned, such that at any particular time, a request to access a first operator may be allowed, but a request to access a second operator may be denied.

In some forms of the invention, the resources allocation rules are defined by one or more service level agreements (SLAs). The service level agreements may be stored at a resources broker.

The said predetermined resources allocation rules may be received from a resources allocation management module. Further, the resources allocation management module may generate said resources allocation rules by converting one or more service level agreements (obtained, for example, from a resources broker) into said resources allocation rules.

The present invention further provides a computer program product comprising: means for determining, for a communication network, network capacity desired by each of a plurality of operators; and means for allocating network capacity of the communication network to the plurality of operators, wherein the network capacity is allocated on the basis of the determined desired network capacities and on the basis of predetermined resources allocation rules.

The present invention further provides a computer program comprising: code for determining, for a communication network, network capacity desired by each of a plurality of operators; and code for allocating network capacity of the communication network to the plurality of operators, wherein the network capacity is allocated on the basis of the determined desired network capacities and on the basis of predetermined resources allocation rules. The computer program may be a computer program product comprising a computer-readable medium bearing computer program code embodied therein for use with a computer.

As discussed above, the current 3GPP SAE/LTE network environment lacks an efficient means to enable dynamic resources brokerage. The present invention enables dynamic resources brokerage by sharing network resources between network operators (such as mobile network operators) and also allowing plain service providers without any network infrastructure to be allocated resources in a 3GPP network. Here the well-known concept of Service Level Agreements (SLAs) may be utilized, meaning that the support of resources brokerage can be based on agreed and signed SLAs (via e.g. a 3^{rd} party resources broker (RB)). The overall process of SLA negotiation, realization and signing can be characterized with slow dynamisms (timescale starting with weeks) so that the network management system (NMS) is foreseen as an adequate interface for such a resources brokerage entity. But NMS lacks an appropriate means to dynamically decide on resources allocation, in real time, per contractual partner. NMS also lacks an appropriate means to enforce resources allocation decisions in the underlying networks.

Embodiments of the invention are described below, by way of example only, with reference to the following schematic drawings.

FIG. 1 is a block diagram of a known system from providing mobile communication services;

FIG. 2 is a block diagram of a LTE system for providing mobile communication services;

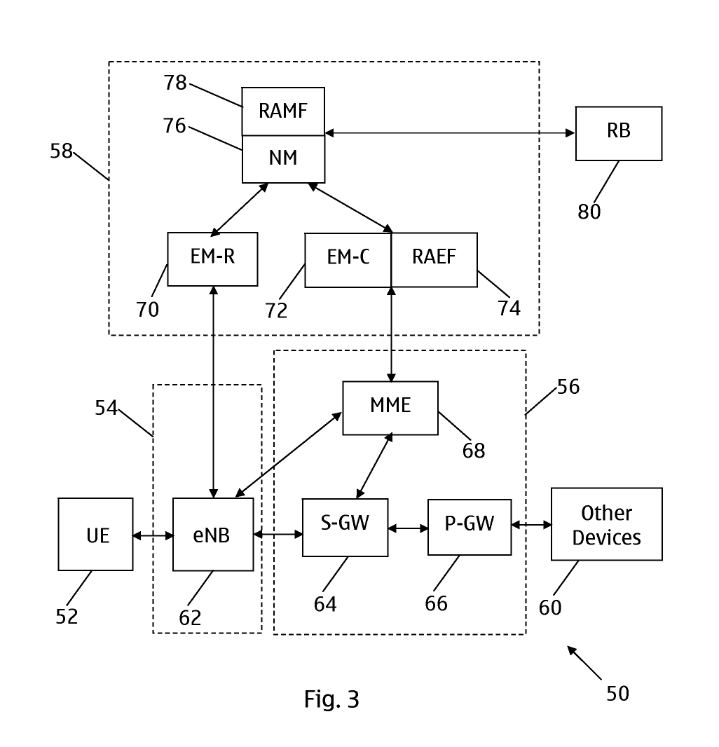

FIG. 3 is a block diagram of a system in accordance with an aspect of the present invention;

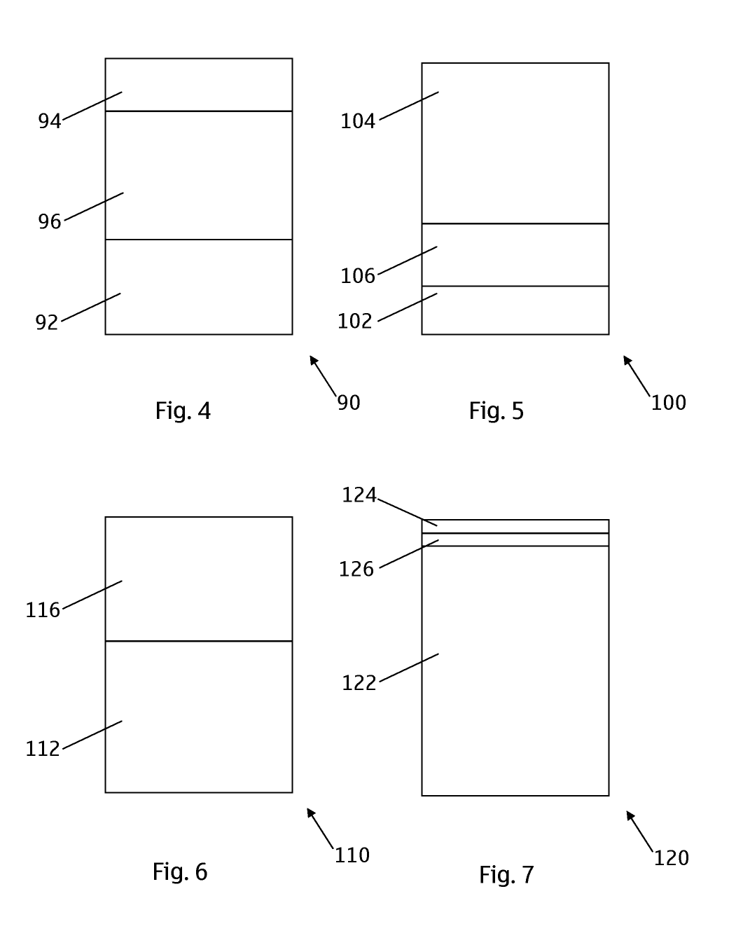

FIG. 4 demonstrates system capacity distribution in accordance with an aspect of the present invention;

FIG. 5 demonstrates system capacity distribution in accordance with an aspect of the present invention;

FIG. 6 demonstrates system capacity distribution in accordance with an aspect of the present invention; and

FIG. 7 demonstrates system capacity distribution in accordance with an aspect of the present invention.

FIG. 3 is a block diagram of an exemplary mobile communication system, indicated generally by the reference numeral 50, in accordance with an aspect of the present invention. The system 50 builds on known LTE systems and makes use of many of the features of the LTE system 20 described above with reference to FIG. 2.

The mobile communication system 50 comprises user equipment (UE) 52, radio access network 54, evolved packet core 56, network management system 58 and other devices and networks 60 that are similar to the user equipment 22, radio access network 24, evolved packet core 26, network management system 28 and other devices and networks 30 of the system 20. The system 50 further comprises a resource broker 80.

The radio access network 54 includes an eNodeB 62, similar to the eNodeB 32 described above.

The evolved packet core 56 comprises a serving gateway (S-GW) 64, packet data network gateway (P-GW) 66 and one or more mobility management entities (MMEs) 68 that are similar to the serving gateway 34, packet data network gateway 36 and mobility management entities 38 described above.

The network management system 58 comprises a radio network element manager (EM-R) 70, a core network element manager (EM-C) 72 and a network manager (NM) 76 similar to the radio network element manager 40, core network element manager 42 and network manager 44 described above respectively. The network management system 58 differs from the system 28 in that the EM-C 72 is associated with a resources allocation enforcement function (RAEF) 74 and in that the network manager 76 is associated with a resources allocation management function (RAMF) 78. Further, the network manager 76 and the associated RAMF 78 are in two-way communication with the resources broker 80.

Thus, the network management system 58 differs from the network management system 28 described above in the provision of a resources allocation (RA) architecture consisting of the RAEF 74 and RAMF 78.

The RAMF 78 converts service level agreements (SLAs) obtained from the resources broker 80 into resources allocation rules per element manager. The RAMF 78 also implements an extended Northbound Interface (ltf-N) and supports extended network resources management as described further below.

The RAEF 74 receives the resources allocation rules set by the RAMF 78, implements the received resources allocation rules per sharing operator, supports extended network resource model (NRM) and implements proprietary interface with associated MMEs.

The resources allocation is enforced by the MMEs 68. The use of the MMEs to enforce resources allocation rules is convenient due to the MMEs' role in controlling the interfacing between the network management system 58 and the radio access networks 54. Following this reasoning the solution extends the Northbound Interface (ltf-N) between NM and EMs (of MMEs) that supports and implements the also extended network resource model (NRM) of MMEs.

A feature of prior art MMEs is the control of overloaded MMEs due to high data traffic rates. It is known for an MME that is overloaded to send an OVERLOAD START message to one or more of the eNodeBs that are using that MME. Using the OVERLOAD START message, the MME can, for example, request the eNodeB to reject all incoming calls that are not being made to one of the emergency services. The MMEs in accordance with the present invention can extend this overload procedure in order to control the capacity allocated to each of the mobile network operators that are sharing the network resources in accordance with the RA rules set by the RAMF 78. To implement this, the known MME control of overload can be extended as set out below.

First, resources of a first network operator are allocated to a second network operator. This is enforced in the core network MME(s) of the concerned MME pool area(s) based on introduced resources allocation (RA) rules, as set out below in detail. The OVERLOAD procedure referred to above is performed independently for each operator, in order to enforce the RA rules.

Further, the MME needs to restrict the load that its eNodeBs are generating on the MME per network operator. This is achieved by the MME invoking the S1 interface overload procedure independently. To reflect the amount of load that the MME wishes to reduce, the MME can adjust the proportion of eNodeBs (from e.g. the second operator) which are sent the S1 interface OVERLOAD START message, and the content of the OVERLOAD START message.

Also, using the OVERLOAD START message, the MME can request that the eNodeB reject all non-emergency Service Request messages for that MME and for a dedicated (sharing) operator.

Further, when the MME load situation allows (depending on the capacity of the operator(s) currently used and the resources allocation rules), the MME sends an OVERLOAD STOP message to the eNodeB(s) and indicates again the concerned (sharing) network(s).

Finally, the MME reports performance indicators, as is done now. However, in the present invention, the performance indicators are provided for each of the operators sharing the network resources. The reported performance indicators, such as, for example, the number of active users or numbers of successful (or attempted) evolved packet system (EPS) bearer modification procedures per MME, may be used within the network management system for monitoring network utilization or performing trend analysis. Already considered use cases are related to e.g. mobility management related, detach related or tracking area related measurements.

The eNB functionality is also extended. The eNB processes the S1 interface overload procedure per network operator. A key difference between the eNB 32 of the system 20 and the eNB 62 of the system 50 is that the overload handling in the eNB 62 has to differentiate between sharing operators. This means, for example, that a new service request from one particular operator may be rejected by the eNB 62, whilst a service request from another operator (that is within its relevant limits) may be accepted and handled as normal.

A number of resource sharing scenarios are described below with reference to FIGS. 4 to 7. The examples described below assume that only two operators (operators A and B) are sharing finite system resources. Of course, the invention can easily be extended for use with more than two operators.

The scenarios shown in FIGS. 4 to 7 assume that a mobile network operator (MNO) (operator A) agrees (via SLAs and the resources broker 80) that resources of its network can be allocated to a second network operator (operator B). This is enforced in the MME(s) of the concerned MME pool area(s) based on introduced resources allocation (RA) rules.

The resources allocation rules may be specified as new Information Object Class (IOC) “SharingOperator”. “SharingOperator”, which has to be set one for each of the operators sharing the network, sets the following values on an EM-C(s) (MME(s)):
1. Minimum capacity.
2. Granted capacity that may be used.
3. Maximum capacity, which may be used if not allocated to other operators.

The IOC “SharingOperator” contains the following attributes:

| | Support | Read | Write |
|---|---|---|---|
| Attribute name | Qualifier | Qualifier | Qualifier |
| minCapacity | M | M | M |
| grantedCapacity | M | M | M |
| maxCapacity | M | M | M |

In the examples of FIGS. 4 to 7, “minimum capacity” refers to the capacity of the network which is always available for the operator B, regardless of the usage of the network by operator B, “granted capacity” refers to the capacity of the network that is available to the operator B, if required by the operator B, and “maximum capacity” refers to the capacity of the network that can be made available to the operator B, provided that the capacity is not required by another operator (operator A in the present examples).

All attributes are proposed as mandatory (M) for the IOC “SharingOperator”, although settings (e.g. optional) are possible. Thus, it is proposed that it is mandatory that the attributes are supported by the vendors, and mandatory that the attributes are readable and writeable. Again other definitions (combinations) are not excluded.

In the examples of FIGS. 4 to 7, the minimum capacity for operator B is 5%, the granted capacity for operator B is 30% and the maximum capacity for operator B is 65%. Thus, the system capacity allocated to the operator B is never less than 5% and is never greater than 65%, as discussed further below. Of course, different capacities could be set.

FIG. 4 is a block diagram, indicated generally by the reference numeral 90, demonstrating system capacity distribution in accordance with an aspect of the present invention. In the capacity distribution 90, the operator A is using 30% of the available capacity (as shown by the block 92), operator B is using 15% of the available capacity (as shown by the block 94) and 55% of the available capacity is unused (as shown by the block 96). Since operator B is using less than the capacity granted to it (30%), the situation shown in FIG. 4 is acceptable and no action is required by the network management system.

FIG. 5 is a block diagram, indicated generally by the reference numeral 100, demonstrating system capacity distribution in accordance with an aspect of the present invention. In the capacity distribution 100, the operator A is using 15% of the available capacity (as shown by the block 102), operator B is using 60% of the available capacity (as shown by the block 104) and 25% of the available capacity is unused (as shown by the block 106). In this example, operator B is using more than the capacity granted to operator B (30%). However, operator B is using less than the maximum capacity for operator B (65%) and, since that capacity is not required by operator A, the situation shown in FIG. 5 is acceptable and no action is required by the network management system.

If, in the capacity distribution 100, the operator B wishes to increase the capacity it used by 10% (to 70%), the operator B would exceed the maximum capacity granted to it, and this would need to be blocked by the relevant MME, for example by making use of the overload procedure described above.

FIG. 6 is a block diagram, indicated generally by the reference numeral 110, demonstrating system capacity distribution in accordance with an aspect of the present invention. In the capacity distribution 110, the operator A is using 60% of the available capacity (as shown by the block 112) and operator B is using 40% of the available capacity (as shown by the block 116). No capacity is unused. Since operator B is using less than the maximum capacity granted to it (65%), the situation shown in FIG. 6 is acceptable and no action is required by the network management system.

If, in the capacity distribution 110, the operator A requested more capacity, this would need to granted at the expense of operator B, since operator B is only allowed more than the granted capacity (30%) if that capacity is not required by operator A. In such a scenario, some of current capacity of the operator B would need to be blocked by the relevant MME, for example by making use of the overload procedure. Similarly, if the operator B requested more capacity, this would need to be blocked by the MME.

FIG. 7 is a block diagram, indicated generally by the reference numeral 120, demonstrating system capacity distribution in accordance with an aspect of the present invention. In the capacity distribution 120, the operator A is using 95% of the available capacity (as shown by the block 122), operator B is using 3% of the available capacity (as shown by the block 124) and 2% of the available capacity is unused (as shown by the block 126). Given that the operator B has a minimum capacity of 5% that must always be available, the operator A cannot be granted any further capacity. Accordingly, if the operator A requested more capacity, this would need to be blocked by the relevant MME, for example by making use of the overload procedure. If operator B requested more capacity, then this would be granted, up to a maximum capacity of 5%. Capacity above 5% could only be granted to operator B if it was no longer being used by operator A.

The transition from SLA to RA rule(s) and the mapping to concerned MME(s) is done by the RAMF 78. This might, for example, be done via a “segmented mapping algorithm”, holding states for each MME (RAEF), which uses a lookup table to map SLA parameters such as quality of service class or ranges of maximum and guaranteed bit rates onto RA rules attributes. Furthermore, the proposed solution utilizes for smooth migration reasoning existing performance indicators (PIs) from MME, which may be, but are not limited to, number of active users or numbers of successful (or attempted) EPS bearer modifications procedures per MME. Hence, “capacity” is equivalent to “number of active users on MME” in an exemplary implementation of the invention.

So, to enable such resources allocation by the operator B, the following functionality of an operator A's MME(s) are provided:
MME(s) support 2 (or more) sharing operators, sharing the MME(s) total capacity based, for example, on the number of active users;
The generated overall load of all users per sharing operator is available for one MME, and provided to NM via extended ltf-N; and
In case of overload situation per sharing operator, the eNB(s) are informed for proper control of overload.

Such a use case as described above can easily be extended for any number of sharing operators; consequently control logics in NM as well as in MME have to cope with extended complexity of providing RA Rule(s) to MME(s) and of processing service requests in the context of a “higher” number of relevant minimum/granted/maximum capacity limits, respectively.

Assigning the network manager 76 as decision point RAMF is reasonable due to the relative static nature of SLAs and its negotiations; this also supports 3rd party RB deployments. Assigning the MME as enforcement point RAEF is also reasonable due to its central (controlling) role in communication (session) setup interfacing both NMS and radio network entities (as eNodeBs).

In FIG. 3, the MME 68 and the EM-C 72 are shown as parts of different functional blocks. It is not, however, essential for those elements to be separated. By way of example, the MME 68 and the EM-C 72 could be provided as one physical entity, or as two separate entities. Thus, the MME may provide the enforcement point RAEF 74, as suggested above.

Considering NMS extensions, RAMF is foreseen as extension for Integration Reference Point Manager (IRP-M) in Network Manager (NM) in NMS, whereas RAEF is foreseen as extension for IRP-Agent (IRP-A) in Element Manager in NMS associated with a MME. Since EM and associated network entity (NE like MME) are from the same infrastructure vendor (consequently interface between both is proprietary, hence not standardized) RAEF is located with EM, but the invention does not exclude other possible realizations.

The embodiments of the invention described above include two overload states: either there is an overload condition, or there is not. Of course, the invention could be extended by enabling the MMEs to take action when the MME is close to, but not at, an overload condition. For example, the arrangement of FIG. 6 may include some action taken to prepare the system to take action in the event that operator A requested more network capacity (which would need to be granted at the expense of operator B).

The present invention is described with reference to Long Term Evolution (LTE), which is a project within the Third Generation Partnership Project (3GPP) to develop mobile communication standards to cope with future technology evolutions. Although the invention is described with reference to 3GPP LTE, the skilled person will be aware that the features of the present invention can be used with other mobile communication system, which could be e.g. an IEEE 802.16′ mobile WiMAX system, in which the EM-C for ASN-GW (Access Services Network Gateway) is relevant in the context of this invention.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method comprising:
determining, for a communication network, network capacity desired by each of a plurality of operators; and
allocating network capacity for the communication network to the plurality of operators, wherein the network capacity is allocated on the basis of the determined desired network capacities and on the basis of predetermined resources allocation rules.

2. A method as claimed in claim 1, wherein the communication network is a mobile communication network.

3. A method as claimed in claim 1, wherein one or more of said operators are mobile network operators.

4. A method as claimed in claim 1, wherein one or more of said operators are service providers.

5. A method as claimed in claim 1, wherein, for a first operator of the plurality of operators, the resources allocation rules define a minimum network capacity, which network capacity is always available for the first operator.

6. A method as claimed in claim 1, wherein, for a first operator of the plurality of operators, the resources allocation rules define a granted network capacity, which network capacity is always available for the said operator, if it is determined that that network capacity is desired by the first operator.

7. A method as claimed in claim 1, wherein, for a first operator of the plurality of operators, the resources allocation rules define a maximum network capacity, which network capacity is available for the said first operator, if it is determined that that network capacity is desired by the first operator and that that network capacity is available.

8. A method as claimed in claim 1, further comprising using an overload procedure to restrict access to said network capacity for one or more of said plurality of operators.

9. A method as claimed in claim 1, wherein the resources allocation rules are defined by one or more service level agreements.

10. An apparatus comprising a resources allocation enforcement module adapted to allocate network capacity of a communication network to each of a plurality of operators that are sharing said network capacity, wherein, for each operator, network capacity is allocated on the basis of predetermined resources allocation rules.

11. An apparatus as claimed in claim 10, wherein said predetermined resources allocation rules are derived from a resources allocation management module.

12. An apparatus as claimed in claim 11, further comprising said resources allocation management module.

13. An apparatus as claimed in claim 11, wherein said resources allocation management module generates said resources allocation rules by converting one or more service level agreements into said resources allocation rules.

14. An apparatus as claimed in claim 10, further comprising one or more mobility management entities for enforcing the allocation of network capacity to said operators.

15. An apparatus as claimed in claim 14, wherein said one or more mobility management entities enforce the allocation of network capacity by sending overload messages to one or more radio access modules used to access said communication network to selectively deny network access to one or more of said operators.

16. A radio access network for a mobile communication system, wherein a plurality of operators share network capacity of the mobile communication system, the radio access network comprising a control system for providing or denying access to the operators on the basis of determined desired network capacities of the operators and on the basis of predetermined resources allocation rules.

17. A computer program product comprising:
means for determining, for a communication network, network capacity desired by each of a plurality of operators; and
means for allocating network capacity of the communication network to the plurality of operators, wherein the network capacity is allocated on the basis of the determined desired network capacities and on the basis of predetermined resources allocation rules.
